(19) United States
(12) Patent Application Publication
(10) Pub. No.: US 2025/0202130 A1
(43) Pub. Date: Jun. 19, 2025

(54) LOW-PROFILE WIDEBAND ANTENNA ARRAY CONFIGURED FOR CONNECTORLESS MOUNTING

(71) Applicant: The MITRE Corporation, Mclean, VA (US)

(72) Inventors: John Patrick LISTON, Wilmington, MA (US); Mohamed Wajih Elsallal, Acton, MA (US)

(73) Assignee: The MITRE Corporation, McLean, VA (US)

(21) Appl. No.: 18/538,820

(22) Filed: Dec. 13, 2023

(51) Int. Cl. H01Q 21/00; H01Q 9/04

(52) U.S. Cl. CPC H01Q 21/0068; H01Q 9/0457

(57) ABSTRACT

A phased array antenna that is configured to enable a connectorless interface between a signal ear of a phased array antenna and a feed line of a printed circuit board is provided. In a first connectorless configuration, a post of a signal ear of a radiating element extends through the base plate beyond a second side of the base plate, and through a via of a PCB. The via is electrically connected to a feed line of the PCB, and the post is soldered to the feed line. In a second connectorless configuration, the signal ear post is connected to a feed line of a PCB by contact with a first ball of a ball grid array (BGA), wherein the first ball is connected to the feed line. The phased array antennas provided herein include single ended antennas and differential antennas.

### STATEMENT OF FEDERALLY SPONSORED RESEARCH OR DEVELOPMENT

This invention was made with government support under 101073.23.304.3DC0.AT0 awarded by the United States Air Force. The government has certain rights in the invention.

### FIELD

This application relates generally to antennas and more specifically to ultra-wideband, multi-band, phased array or electronically scanned array antennas configured for connectorless mounting and/or differential signal transmission.

### BACKGROUND

There are increasing demands to develop a wideband phased array or electronically scanned array (ESA) that include a wide variety of configurations for various applications, such as satellite communications (SATCOM), radar, remote sensing, direction finding, and other systems. The goal is to provide more flexibility and functionality at reduced cost with consideration to limited space, weight, and power consumption (SWaP) on modern military and commercial platforms. This requires advances in ESA and manufacturing technologies.

A phased array antenna is an array of antenna elements in which the phases of respective signals feeding the antenna elements are set in such a way that the effective radiation pattern of the array is reinforced in a desired direction and suppressed in undesired directions, thus forming a beam. The relative amplitudes of constructive and destructive interference effects among the signals radiated by the individual elements determine the effective radiation pattern of the phased array. The number of antenna elements in a phased array antenna is often dependent on the required gain of a particular application and can range from isotropic to highly directive level.

Existing phased array antennas implement a variety of interconnect configurations for connecting signal ears to transmission feed lines. For instance, conventional phased array antennas often employ SMA connectors for connecting signal ears to co-axial cables. However, such existing interconnect configurations require substantial manual assembly.

### SUMMARY

According to various embodiments, a phased array antenna has a feed network that includes a printed circuit board (PCB) that directly connects to signal ears of radiating elements of the phased array antenna. Thus, the signals ears are connected to signal lines of the feed network without requiring the use of connectors. This connectorless interface between the signals ears and the feed network can provide faster assembly and more compact design.

According to various embodiments, the phased array antenna includes a base plate and a plurality of radiating antenna elements that include signals ears that have posts that extend through the base plate. The posts are soldered directly to a printed circuit board that includes feed lines for routing signals to the signals ears. In some embodiments, a post of a signal ear of a radiating element extends through the base plate of the phased array antenna and through a PCB mounted to the back side of the based plate. The post is soldered to a pad of the PCB that is connected to a feed line of the PCB.

In some embodiments, the signal ear posts are connected to the feed lines of a PCB via a ball grid array (BGA), which may be disposed between the base plate and the PCB or between a first PCB and a second PCB. In some embodiments, balls of the BGA that are not electrically connected to the signal ears provide a path to ground between the PCB and the base plate and provide an electromagnetic shield around the respective connection between the signal ear and BGA ball.

The radiating elements may include ground ears that may be grounded to the base plate and, as such, not connected to the PCB. In other embodiments, the radiating elements may be configured as differential antenna elements in which both ears are signal ears connected to respective feed lines of the PCB via a connecterless interface.

According to an aspect, an exemplary phased array antenna comprises a base plate; and a plurality of unit cells, wherein each unit cell comprises: a signal ear that extends outwardly from a first side of the base plate, the signal ear comprising a post that extends through the base plate beyond a second side of the base plate, wherein the post is electrically isolated from the base plate; and a first printed circuit board (PCB) comprising a feed line directly connected to the post.

In some embodiments, the post extends through an airgap or a dielectric material disposed within the base plate. In some embodiments, the phased array antenna further comprises a ground ear that extends outwardly from the first side of the base plate, the ground ear comprising a post connected to the base plate. In some embodiments, the post is directly connected to the first PCB by extending the post through a through-hole of the first PCB from a first side of the PCB to a second side of the PCB and soldering the post to a catch pad on the second side of the PCB. In some embodiments, the through-hole is electrically connected to the feed line. In some embodiments, the feed line is electrically isolated from a conductive surface on the second side of the PCB comprising the feed line. In some embodiments, the first PCB comprises a plurality of grounding vias, wherein the plurality of grounding vias are electrically connected to the base plate to provide a path to ground. In some embodiments, the plurality of grounding vias form an electromagnetic shield around the post.

In some embodiments, a second PCB is disposed between the base plate and the first PCB, and wherein the post extends through a through-hole of the second PCB, wherein the second PCB does not comprise a feed line, and the post is directly connected to the first PCB. In some embodiments, the post is directly connected to the first PCB by connecting the post to a first ball of a ball grid array (BGA) disposed between the second PCB and the first PCB, wherein the first ball contacts the feed line. In some embodiments, the second PCB comprises a plurality of grounding vias, wherein the plurality of grounding vias are electrically connected to the base plate to provide a path to ground. In some embodiments, the one or more grounding vias are electrically isolated from the through-hole through which the post extends. In some embodiments, a grounding via of the plurality of grounding vias contacts a second ball of the BGA in contact with a conductive surface of the first PCB to provide a path to ground between the base plate, the first PCB, and the second PCB. In some embodiments, the grounding via and the second ball form a part of an electromagnetic shield around the post.

According to an aspect, an exemplary phased array antenna comprises: a base plate; and a plurality of unit cells, wherein each unit cell comprises: a signal ear comprising a post, wherein the post is electrically isolated from the base plate, and wherein the post is connected to a first printed circuit board (PCB) comprising a feed line by a contact with a first ball of a ball grid array (BGA), wherein the first ball is connected to the feed line. In some embodiments, the post extends through an airgap disposed within the base plate. In some embodiments, the post extends through a dielectric material disposed within the base plate. In some embodiments, the phased array antenna further comprises a ground ear that extends outwardly from the first side of the base plate, the ground ear comprising a post connected to the base plate. In some embodiments, the BGA is disposed between the base plate and the first PCB comprising the feed line. In some embodiments, a plurality of balls of the BGA other than the first ball form an electromagnetic shield around the first ball and the post.

In some embodiments, a second PCB is disposed between the base plate and the first PCB, and wherein the BGA is disposed between the second PCB and the first PCB. In some embodiments, the post extends through a through-hole of the second PCB, wherein the second PCB does not comprise a feed line, and the post is directly connected to the first PCB by contact with the first ball of the BGA disposed between the second PCB and the first PCB. In some embodiments, the second PCB comprises a plurality of grounding vias, wherein the plurality of grounding vias are electrically connected to the base plate and the first PCB to provide a path to ground between the base plate, the first PCB, and the second PCB. In some embodiments, the plurality of grounding vias are electrically isolated from the through-hole through which the post extends. In some embodiments, a grounding via of the plurality of grounding vias contacts a second ball of the BGA, and wherein the second ball contacts a conductive surface of the first PCB to provide a path to ground between the base plate, the first PCB, and the second PCB. In some embodiments, the grounding via and the second ball form a part of an electromagnetic shield around the post.

According to an aspect, an exemplary phased array antenna comprises: a base plate configured to provide a path to ground; and a plurality of unit cells, wherein a first unit cell comprises a first signal ear and a second signal ear adjacent to the first signal ear for generating a signal based on a differential signal pair, and wherein the first signal ear comprises a first post electrically isolated from the base plate and second signal ear comprises a second post electrically isolated from the base plate.

In some embodiments, the first signal ear is connected to a first feed line by a contact between the first post and the first feed line, and wherein the second signal ear is connected to a second feed line by a contact between the second post and the second feed line. In some embodiments, the first and second feed line are provided on a first PCB. In some embodiments, the first post is connected to the first feed line by extending the first post through a first through-hole of the first PCB from a first side of the first PCB to a second side of the first PCB and soldering the first post to a first catch pad electrically connected to the first feed line on the second side of the first PCB. In some embodiments, the second post is connected to the second feed line by extending the second post through a second through-hole of the first PCB from a first side of the first PCB to a second side of the first PCB and soldering the second post to the second catch pad electrically connected to the second feed line on the second side of the first PCB.

In some embodiments, a second PCB is disposed between the base plate and the first PCB, and wherein the first and second feed line are provided on the first PCB, and wherein a ball grid array (BGA) is disposed between the first PCB and the second PCB. In some embodiments, the first post extends through a first through-hole of the second PCB and the second post extends through a second through-hole of the second PCB, and wherein the first post directly connects to the first feed line by contacting a first ball of the BGA in contact with the first feed line, and wherein the second post directly connects to the second feed line by contacting a second ball of the BGA in contact with the second feed line. In some embodiments, the first PCB and second PCB respectively comprise one or more grounding vias, wherein the one or more grounding vias are electrically connected to the base plate to provide a path to ground. In some embodiments, the one or more grounding vias are electrically isolated from the first through-hole and the second through-hole. In some embodiments, the one or more grounding vias respectively contact one of more balls of the BGA other than the first ball and the second ball, and wherein the one of more balls of the BGA other than the first ball and the second ball contact a conductive surface of the first PCB and the second PCB to provide a path to ground between the base plate, the first PCB, and the second PCB. In some embodiments, the base plate comprises a plurality of airgaps disposed within the base plate. In some embodiments, the first post is disposed within a first airgap of the plurality of airgaps and the second post is disposed within a second airgap of the plurality of airgaps. In some embodiments, the first signal ear comprises a third post connected to the base plate and the second signal ear comprises a fourth post connected to the base plate.

### BRIEF DESCRIPTION OF THE FIGURES

FIG. 1A illustrates a plan view of a general dual-polarized phased array antenna according to examples of the disclosure.

FIG. 1B is a unit cell of a general dual-polarized phased array antenna according to examples of the disclosure.

FIG. 2A is an isometric view of a dual-polarized phased array antenna according to examples of the disclosure.

FIG. 2B is a top view of a dual-polarized phased array antenna according to examples of the disclosure.

FIG. 2C is an isometric view of a unit cell of a dual-polarized phased array antenna according to examples of the disclosure.

FIG. 3A is an isometric view of a unit cell of dual-polarized phased array antenna according to examples of the disclosure.

FIG. 3B is a side view of a unit cell of dual-polarized phased array antenna according to examples of the disclosure.

FIG. 3C is a top view of a unit cell of dual-polarized phased array antenna according to examples of the disclosure.

FIG. 4A is an isometric view of a unit cell of a phased array antenna configured for a connectorless interconnect between the unit cell and a PCB according to examples of the disclosure.

FIG. 4B is an isometric view of a PCB configured to connect to the unit cell of FIG. 4A according to examples of the disclosure.

FIG. 4C is an isometric view of the unit cell from FIG. 4A and the PCB of FIG. 4B connected according to examples of the disclosure.

FIG. 5 is a front section view of a single-ended phased array antenna connected to a PCB using a ball grid array according to examples of the disclosure.

FIG. 6 is a front section view of a differential phased array antenna connected to a PCB according to examples of the disclosure.

FIG. 7 is a front section view of a phased array antenna connected to a PCB using a ball grid array according to examples of the disclosure.

FIG. 8 is a front section view of a phased array antenna connected to a PCB using a ball grid array disposed between a first and second PCB according to examples of the disclosure.

### DETAILED DESCRIPTION

Described herein, according to various embodiments, are phased array antennas including signal ears that connect directly to a feed network that includes a printed circuit board. In some embodiments, the signal ears of the phased array antenna include posts that extend through a base plate of the antenna and can be soldered to feed lines provided on the printed circuit board. Extending the signal ear posts through the base plate allows for a direct electrical connection between the signal ear and respective feed line without the need for additional connectors.

In some embodiments, the post extends through a PCB that is mounted to the back side of the base plate and may be soldered to the backside of the PCB through which it extends or may be soldered to a second PCB that is mounted to the one through which it extends. In some embodiments, the signal ears are connected to a PCB via a BGA. The BGA may be located between the base plate and the PCB or may be located between two PCBs. As such, the signal ears of the phased array antenna can be directly connected to transmission feed lines provided on PCBs without any need for additional connectors. In some embodiments, the radiating elements include ground ears, which may be grounded to the base plate and not connected to the PCB. A signal beam can be generated by exciting the radiating element to generate a voltage differential between a signal ear and ground ear.

In some embodiments, each of the ears of the radiating elements are both signal or active ears that are connected to respective feed lines, thus forming a differential pair of signal ears. Each feed line can provide a respective signal to one of the signal ears, forming a differential signal pair, and the pair of signal ears generates a single signal for transmission based on the differential pair. The pair of signal ears of a differential radiating element may be positioned close together, which may make it difficult to use connectors to connect the differential pair of radiating elements to a feed network. The connectorless mounting of a PCB-based feed network directly to the radiating elements, as described herein, may eliminate this difficulty. The differential radiating element configuration provides a number of technical advantages. For instance, in some embodiments, the antennas described herein are balanced antennas, and a differential feed is a straightforward way to excite a balanced antenna because it does not require the use of a balun for impedance transformation.

In the following description of the disclosure and embodiments, reference is made to the accompanying drawings in which are shown, by way of illustration, specific embodiments that can be practiced. It is to be understood that other embodiments and examples can be practiced and changes can be made without departing from the scope of the disclosure.

In addition, it is also to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units, but do not preclude the presence or addition of one or more other features, integers, steps, operations, elements, components, units, and/or groups thereof.

Reference is sometimes made herein to an array antenna having a particular configuration (e.g. a planar array). One of ordinary skill in the art would appreciate that the techniques described herein are applicable to various sizes and shapes of array antennas. It should thus be noted that although the description provided herein describes the concepts in the context of a rectangular array antenna, those of ordinary skill in the art would appreciate that the concepts equally apply to other sizes and shapes of array antennas including, but not limited to, arbitrarily shaped planar array antennas as well as cylindrical, conical, spherical and arbitrarily shaped conformal array antennas.

Reference is also made herein to the array antenna including radiating elements of a particular size and shape. For example, certain embodiments of radiating element are described having a shape and a size compatible with operation over a particular frequency range (e.g. 2-30 GHz). Those of ordinary skill in the art would recognize that other shapes of antenna elements may also be used and that the size of one or more radiating elements may be selected for operation over any frequency range in the RF frequency range (e.g. any frequency in the range from below 20 MHz to above 50 GHz).

Reference is sometimes made herein to generation of an antenna beam having a particular shape or beam width. Those of ordinary skill in the art would appreciate that antenna beams having other shapes and widths may also be used and may be provided using known techniques such as by inclusion of amplitude and phase adjustment circuits into appropriate locations in an antenna feed circuit.

Described herein are embodiments of frequency-scaled ultra-wide spectrum phased array antennas. These phased array antennas are formed of repeating cells of frequency-scaled ultra-wide spectrum radiating elements. Phased array antennas according to certain embodiments exhibit very low profile, wide bandwidth, low cross-polarization, and high scan-volume while being low cost, small aperture, modular with built-in RF interconnect, and scalable.

A unit cell of a frequency-scaled ultra-wide spectrum phased array antenna, according to various embodiments, includes a pattern of radiating elements. According to various embodiments, the radiating elements are formed of substrate-free, interlacing components that include a pair of metallic ears (e.g., solid metal or metal plating of a non-metallic substrate such as plastic) that form a coplanar transmission line. In some embodiments, one of the ears is the ground component of the radiating element and can be terminated directly to the array's base plate and the other ear is the signal or active line of the radiating element and can be connected to a feed line of a PCB. In other embodiments, each of the ears of the radiating elements are signal or active lines and can be connected to respective feed lines of the PCB, thus forming a differential pair of signal ears, as described further throughout. According to certain embodiments, the edge of the radiating elements (the edge of the ears) are shaped to encapsulate a cross-shape metallic clustered pillar, which controls the capacitive component of the antenna and can allow good impedance matching at the lower-frequency end of the bandwidth, effectively increasing the operational bandwidth. This has the advantage of a phased array antenna in which no wideband impedance matching network or special mitigation to a ground plane is needed. According to certain embodiments, capacitive coupling may be achieved between two radiating elements directly adjacent to one another, omitting the clustered pillar. For instance, a signal ear may capacitively couple directly to an adjacent signal ear or an adjacent ground ear. Radiating elements can be for transmit, receive, or both. Phased array antennas can be built as single polarized or dual polarized by implementing the appropriate radiating element pattern, as described below.

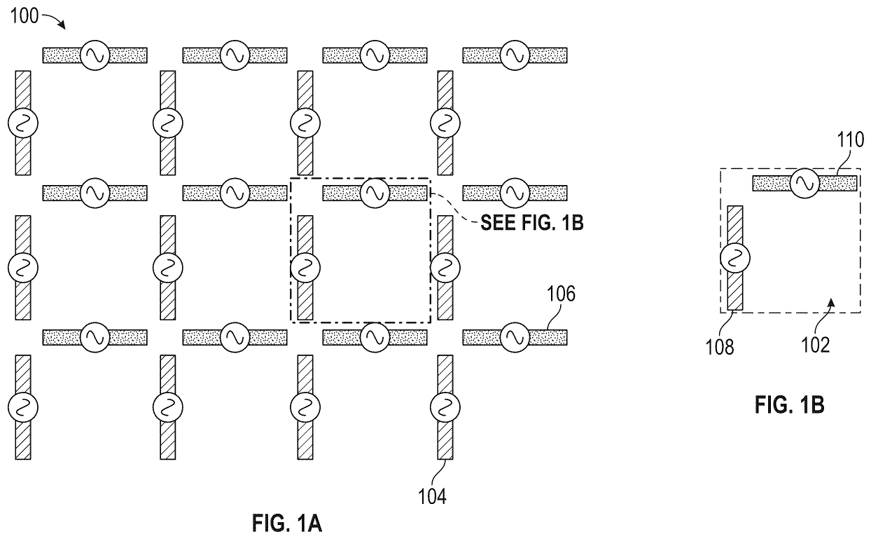

FIG. 1A illustrates an antenna array of radiating elements 100 according to certain embodiments. A dual polarized configuration is shown with radiating elements oriented both horizontally 106 and vertically 104. In this embodiment, a unit cell 102 includes a single horizontally polarized radiating element 110 and a single vertically polarized radiating element 108 (FIG. 1B). Array 100 is a 4×3 array of unit cells 102. According to certain embodiments, array 100 can be scaled up or down to operate over a specified frequency range. More unit cells can be added to meet other specific design requirements such as antenna gain. According to certain embodiments, modular arrays of a predefined size may be combined into a desired configuration to create an antenna array to meet the required performance. For example, a module may include the 4×3 array of radiating elements 100 illustrated in FIG. 1A. A particular antenna application requiring 96 radiating elements can be built using eight modules fitted together (thus, providing the 96 radiating elements). This modular design allows for antenna arrays to be tailored to specific design requirements at a lower cost.

As shown in FIG. 1B, radiating element 108 is disposed along a first axis and element 110 is disposed along a second axis that is orthogonal to the first axis, such that element 108 is substantially orthogonal to element 110. This orthogonal orientation results in each unit cell 102 being able to generate orthogonally directed electric field polarizations. That is, by disposing one set of elements (e.g. vertical elements 104) in one polarization direction and disposing a second set of elements (e.g. horizontal elements 106) in the orthogonal polarization direction, an antenna which can generate signals having any polarization is provided. In this particular example, unit cells 102 are disposed in a regular pattern, which here corresponds to a square grid pattern. Those of ordinary skill in the art would appreciate that unit cells 102 need not all be disposed in a regular pattern. In some applications, it may be desirable or necessary to dispose unit cells 102 in such a way that radiating elements 108 and 110 of each unit cell 102 are not aligned between every unit cell 102. Thus, although shown as a square lattice of unit cells 102, it would be appreciated by those of ordinary skill in the art, that antenna 100 could include but is not limited to a rectangular or triangular lattice of unit cells 102 and that each of the unit cells can be rotated at different angles with respect to the lattice pattern.

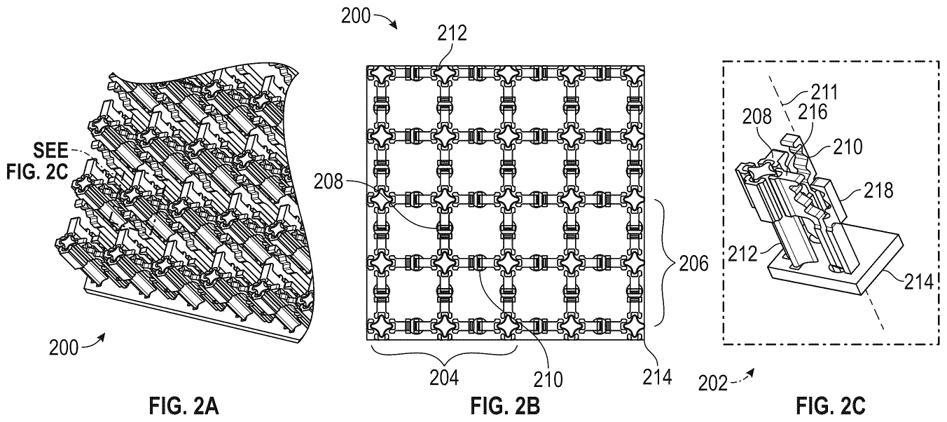

An array of radiating elements 200 according to certain embodiments is illustrated in FIGS. 2A and 2B. Array 200 is a dual-polarized configuration with multiple columns of radiating elements 204 oriented along a first polarization axis (referred to herein as vertically polarized) and multiple rows of radiating elements 206 oriented along a second polarization axis (referred to herein as horizontally polarized) affixed to base plate 214. A unit cell 202 of array 200 is shown in detail in FIG. 2C. Unit cell 202 includes two radiating elements, a vertically polarized radiating element 208 and a horizontally polarized radiating element 210. Horizontally polarized radiating element 210 includes signal ear 216 and ground ear 218. A signal beam is generated by exciting radiating element 210, i.e. by generating a voltage differential between signal ear 216 and ground ear 218. The generated signal beam has a direction along the centerline 211 of radiating element 210, perpendicular to base plate 214. Centerline 211 is the phase center of radiating element 210. A signal beam generated by exciting radiating element 208, has a phase center midway between its respective signal and ground ear. As shown in the embodiments of FIGS. 2A-2C, the phase centers of radiating elements 204 are not co-located with the phase centers of radiating elements 206.

In the embodiments of FIG. 2A-C, the radiating elements 204 are of the same size, shape, and spacing as radiating elements 206. However, phased array antennas according to other embodiments, may include only single polarized radiating elements (e.g., only rows of radiating elements 206). According to some embodiments, the spacing of one set of radiating elements (e.g., the horizontally polarized radiating elements 206) is different from the spacing of the other set of radiating elements (e.g., the vertically polarized elements 204). According to some embodiments, the radiating element spacing within a row may not be uniform. For example, the spacing between first and second radiating elements within a row may be different than the spacing between the second and third elements.

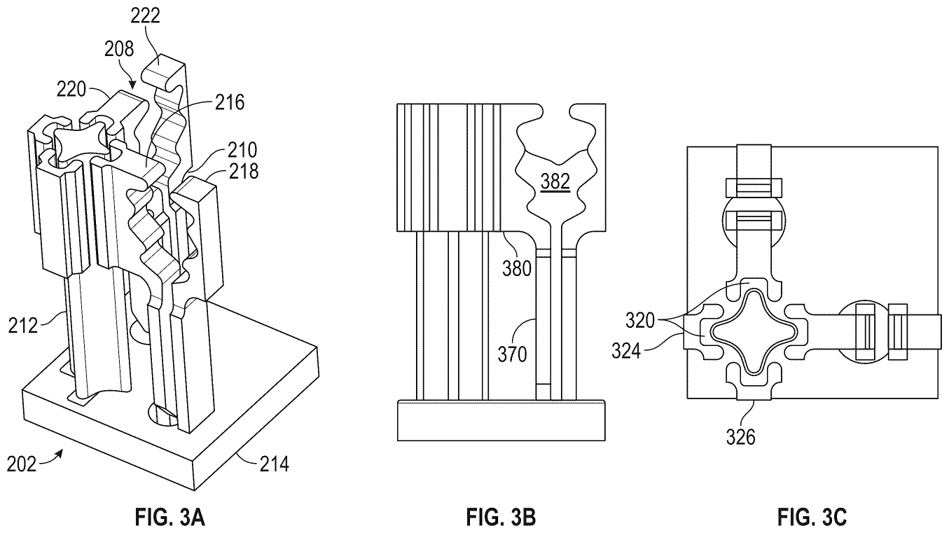

FIGS. 3A, 3B, and 3C provide enlarged views of unit cell 202 according to certain embodiments. Radiating element 208 includes signal ear 220 and ground ear 222. Clustered pillar 212 and ground ear 222 may be both electrically coupled to base plate 214 such that no (or minimal) electrical potential is generated between them during operation. Signal ear 220 is electrically isolated (insulated) from base plate 214, clustered pillar 212, and ground ear 222. According to certain embodiments, a second set of radiating elements 210 are disposed along a second, orthogonal axis. Radiating element 210 includes signal ear 216 and ground ear 218. Clustered pillar 212 and ground ear 218 may be both electrically coupled to base plate 214 such that no (or minimal) electrical potential is generated between them during operation. According to certain embodiments, clustered pillar 212 and ground ear 218 are not electrically connected to base plate 214 but instead to a separate ground circuit. Signal ear 216 is electrically isolated (insulated) from base plate 214, clustered pillar 212, and ground ear 218.

According to certain embodiments, the edges of the radiating elements (the edge of the ears) are shaped to encapsulate cross-shaped metallic clustered pillar 212 to capacitively couple adjacent radiating elements during operation. This can enhance the capacitive component of the antenna, which allows a good impedance match at the low-frequency end of the bandwidth. Through this coupling of clustered pillar 212, each radiating element in a row or column is electromagnetically coupled to ground and the previous and next radiating element in the row or column.

Capacitive coupling is achieved by maintaining a gap 320 between a radiating element ear and its adjacent clustered pillar, which creates interdigitated capacitance between the two opposing surfaces of gap 320. According to certain embodiments, capacitive coupling may be achieved between two radiating elements directly adjacent to one another, omitting the clustered pillar. For instance, a signal ear may capacitively couple directly to an adjacent signal ear or an adjacent ground ear. This capacitance can be used to improve the impedance matching of the antenna. Capacitive coupling can be controlled by changing the overlapped surface area of gap 320 and width of gap 320 (generally, higher capacitance is achieved with larger surface area and less width). According to certain embodiments, signal ears 220 and 216 and ground ears 222 and 218 wrap around the cross shape of clustered pillar 212 in order to maximize the surface area. However, other designs for maximizing the capacitive surface area are also contemplated. For example, a clustered pillar and adjacent ear can form interlacing fingers when viewed from above (e.g., the view of FIG. 3C) or interlacing fingers when viewed from the side (e.g., the view of FIG. 3B). According to certain embodiments, gap 320 is less than 0.1 inches, preferably less than 0.05 inches, and more preferably less than 0.01 inches. According to some embodiments, gap 320 may be scaled with frequency (for example, gap 320 may be a function of the wavelength of the highest designed frequency, λ). For example, according to some embodiments, gap 320 can be less than 0.05 λ, less than 0.025 λ, or less than 0.013 λ. According to some embodiments, gap 320 is greater than 0.005 λ, greater than 0.01 λ, greater than 0.025 λ, greater than 0.05λ, or greater than 0.1 λ. As shown in FIG. 3B, according to certain embodiments, the radiating ears include stem portions 370 extending from base plate 214 to comb portions 380 that include a plurality of irregularly shaped projections 382. According to certain embodiments, gap 320 extends perpendicularly to base plate 214 (i.e., along the length of the clustered pillar/radiating element) for the same distance and located adjacent comb portion 380.

Interdigitated capacitance enables some coupling between adjacent radiating elements in a row (or column). In other words, the electromagnetic field from a first radiating element communicates from its ground ear across the adjacent gap to the adjacent clustered pillar through the interdigitated capacitance and then across the opposite gap to the adjacent signal ear of the next radiating element. Referring to FIGS. 3A and C, which shows a top view of unit cell 202, clustered pillar 212 is surrounded by four radiating element ears. On the right side is signal ear 216 of radiating element 210. On the left side is the ground ear 324 of the next radiating element along that axis. On the top side is signal ear 220 of radiating element 208. On the bottom side is the ground ear 326 of the next radiating element along that axis. Capacitive coupling between clustered pillar 212 and each ear 216 and 324 created by adjacent gaps 320 enable the electromagnetic field of radiating element 208 to couple to the electromagnetic field of the next radiating element (the radiating element of ground ear 324), and capacitive coupling between clustered pillar 212 and each ear 220 and 326 created by respective adjacent gaps 320 enable the electromagnetic field of radiating element 210 to couple to the electromagnetic field of the next radiating element (the radiating element that includes ground ear 326).

It should be understood that the illustrations of unit cell 202 in 2C, 3A, 3B, and 3C truncate ground ears 324 and 326 on the left and bottom side of clustered pillar 212 for illustrative purposes only. One of ordinary skill in the art would understand that the relative orientation of one set of radiating elements to an orthogonal set of radiating elements, as described herein, is readily modified, i.e. a signal ear could be on the left side of clustered pillar 212 with a ground ear being on the right side, and/or a signal ear could be on the bottom side of clustered pillar 212 with a ground ear being on the top side (relative to the view of FIG. 3C).

According to certain embodiments, base plate 214 is formed from one or more conductive materials, such as metals like aluminum, copper, gold, silver, beryllium copper, brass, and various steel alloys. According to certain embodiments, base plate 214 is formed from a non-conductive material such as various plastics, including Acrylonitrile butadiene styrene (ABS), Nylon, Polyamides (PA), Polybutylene terephthalate (PBT), Polycarbonates (PC), Polyetheretherketone (PEEK), Polyetherketone (PEK), Polyethylene terephthalate (PET), Polyimides, Polyoxymethylene plastic (POM/Acetal), Polyphenylene sulfide (PPS), Polyphenylene oxide (PPO), Polysulphone (PSU), Polytetrafluoroethylene (PTFE/Teflon), or Ultra-high-molecular-weight polyethylene (UHMWPE/UHMW), that is plated or coated with a conductive material such as gold, silver, copper, or nickel. According to certain embodiments, base plate 214 is a solid block of material with holes, slots, or cut-outs to accommodate clustered pillars 212, signal ears 216 and 220, and ground ears 218 and 222 on the top (radiating) side and connectors on the bottom side to connect feed lines. In other embodiments, base plate 214 includes cutouts to reduce weight.

According to certain embodiments, base plate 214 is designed to be modular and includes features in the ends that can mate with adjoining modules. Such interfaces can provide both structural rigidity and cross-interface conductivity. Modules may be various sizes incorporating various numbers of unit cells of radiating elements. According to certain embodiments, a module is a single unit cell. According to certain embodiments, modules are several unit cells (e.g., 2×2, 4×4), dozens of unit cells (e.g., 5×5, 6×8), hundreds of unit cells (e.g., 10×10, 20×20), thousands of unit cells (e.g., 50×50, 100×100), tens of thousands of unit cells (e.g., 200×200, 400×400), or more. According to certain embodiments, a module is rectangular rather than square (i.e., more cells along one axis than along the other).

According to certain embodiments, modules align along the centerline of a radiating element such that a first module ends with a ground clustered pillar and the next module begins with a ground clustered pillar. The base plate of the first module may include partial cutouts along its edge to mate with partial cutouts along the edge of the next module to form a receptacle to receive the radiating elements that fit between the ground clustered pillars along the edges of the two modules. According to certain embodiments, the base plate of a module extends further past the last set of ground clustered pillars along one edge than it does along the opposite edge in order to incorporate a last set of receptacles used to receive the set of radiating elements that form the transition between one module and the next. In these embodiments, the receptacles along the perimeter of the array remain empty. According to certain embodiments, a transition strip is used to join modules, with the transition strip incorporating a receptacle for the transition radiating elements. According to certain embodiments, no radiating elements bridge the transition from one module to the next. Arrays formed of modules according to certain embodiments can include various numbers of modules, such as two, four, eight, ten, fifteen, twenty, fifty, a hundred, or more.

In some embodiments, base plate 214 may be manufactured in various ways including machined, cast, or molded. In some embodiments, holes or cut-outs in base plate 214 may be created by milling, drilling, formed by wire EDM, or formed into the cast or mold used to create base plate 214. Base plate 214 can provide structural support for each radiating element and clustered pillar and provide overall structural support for the array or module. Base plate 214 may be of various thicknesses depending on the design requirements of a particular application. For example, an array or module of thousands of radiating elements may include a base plate that is thicker than the base plate of an array or module of a few hundred elements in order to provide the required structural rigidity for the larger dimensioned array. According to certain embodiments, the base plate is less than 6 inches thick. According to certain embodiments, the base plate is less than 3 inches thick, less than 1 inch thick, less than 0.5 inches thick, less than 0.25 inches thick, or less than 0.1 inches thick. According to certain embodiments, the base plate is between 0.2 and 0.3 inches thick. According to some embodiments, the thickness of the base plate may be scaled with frequency (for example, as a function of the wavelength of the highest designed frequency, λ). For example, the thickness of the base plate may be less than 1.0 λ, 0.5 λ, or less than 0.25λ. According to some embodiments, the thickness of the base plate is greater than 0.1 λ, greater than 0.25 λ, greater than 0.5 λ, or greater than 1.0 λ.

According to certain embodiments, radiating ears 216, 218, 220 and 222 and clustered pillar 212 may be formed from any one or more materials suitable for use in a radiating antenna. These may include materials that are substantially conductive and that are relatively easy to machine, cast and/or solder or braze. For example, one or more radiating ears 216, 218, 220 and 222 and clustered pillar 212 may be formed from copper, aluminum, gold, silver, beryllium copper, or brass. In some embodiments, one or more radiating ears 216, 218, 220 and 222 and clustered pillar 212 may be substantially or completely solid. For example, one or more radiating ears 216, 218, 220 and 222 and clustered pillar 212 may be formed from a conductive material, for example, substantially solid copper, brass, gold, silver, beryllium copper, or aluminum. In other embodiments, one or more radiating ears 216, 218, 220 and 222 and clustered pillar 212 are substantially formed from non-conductive material, for example plastics such as ABS, Nylon, PA, PBT, PC, PEEK, PEK, PET, Polyimides, POM, PPS, PPO, PSU, PTFE, or UHMWPE, with their outer surfaces coated or plated with a suitable conductive material, such as copper, gold, silver, or nickel.

In other embodiments, one or more radiating ears 216, 218, 220 and 222 and clustered pillar 212 may be substantially or completely hollow, or have some combination of solid and hollow portions. For example, one or more radiating ears 216, 218, 220 and 222 and clustered pillar 212 may include a number of planar sheet cut-outs that are soldered, brazed, welded or otherwise held together to form a hollow three-dimensional structure. According to some embodiments, one or more radiating ears 216, 218, 220 and 222 and clustered pillar 212 are machined, molded, cast, or formed by wire-EDM. According to some embodiments, one or more radiating ears 216, 218, 220 and 222 and clustered pillar 212 are 3D printed, for example, from a conductive material or from a non-conductive material that is then coated or plated with a conductive material.

Returning to the examples of FIGS. 2A-2C, the phased array antenna 200, according to certain embodiments, has a designed operational frequency range, e.g., 1 to 30 GHz, 2 to 30 GHz, 3 to 25 GHz, and 3.5 to 21.5 GHz. According to certain embodiments, the phased array antenna is designed to operate at a frequency of at least 1 GHz, at least 2 GHz, at least 3 GHz, at least 5 GHz, at least 10 GHz, at least 15 GHz, or at least 20 GHz. According to certain embodiments, the phased array antenna is designed to operate at a frequency of less than 50 GHz, less than 40 GHz, less than 30 GHz, less than 25 GHz, less than 22 GHz, less than 20 GHz, or less than 15 GHz. The sizing and positioning of radiating elements can be designed to effectuate these desired frequencies and ranges. For example, the spacing between a portion of a first radiating element and the portion of the next radiating element along the same axis may be equal to or less than about one-half a wavelength, λ, of a desired frequency (e.g., highest design frequency). According to some embodiments, the spacing may be less than 1λ, less than 0.75 λ, less than 0.66 λ, less than 0.33 λ, or less than 0.25 λ. According to some embodiments, the spacing may be equal to or greater than 0.25 λ, equal to or greater than 0.5 λ, equal to or greater than 0.66 λ, equal to or greater than 0.75 λ, or equal to or greater than 1 λ.

Additionally, the height of radiating element 208 and 210 may be less than about one-half the wavelength of the highest desired frequency. According to some embodiments, the height may be less than 1 λ, less than 0.75 λ, less than 0.66 λ, less than 0.33), or less than 0.25 λ. According to some embodiments, the height may be equal to or greater than 0.25 λ, equal to or greater than 0.5 λ, equal to or greater than 0.66 λ, equal to or greater than 0.75 λ, or equal to or greater than 1 λ. For example, according to certain embodiments where the operational frequency range is 2 GHz to 14 GHz, with the wavelength at the highest frequency, 14 GHz, being about 0.84 inches, the spacing from one radiating element to another radiating element is less than about 0.42 inches. According to certain embodiments, for this same operating range, the height of a radiating element from the base plate is less than about 0.42 inches.

As another example, according to certain embodiments where the operational frequency range is 3.5 GHz to 21.5 GHz, with the wavelength at the highest frequency, 21.5 GHz, being about 0.6 inches, the spacing from one radiating element to another radiating element is less than about 0.3 inches. According to certain embodiments, for this same operating range, the height of a radiating element from the base plate is less than about 0.3 inches. It should be appreciated decreasing the height of the radiating elements can improve the cross-polarization isolation characteristic of the antenna. It should also be appreciated that using a radome (an antenna enclosure designed to be transparent to radio waves in the operational frequency range) can provide environmental protection for the array. The radome may also serve as a wide-angle impedance matching (WAIM) that improves the voltage standing wave ration (VSWR) of the array at wide-scan angles (improves the impedance matching at wide-scan angles).

According to certain embodiments, more spacing between radiating elements eases manufacturability. However, as described above, a maximum spacing can be selected to prevent grating lobes at the desired scan volumes. According to certain embodiments, the selected spacing reduces the manufacturing complexity, sacrificing scan volume, which may be advantageous where scan volume is not critical.

According to certain embodiments, the size of the array is determined by the required antenna gain. For example, for certain application over 40,000 elements are required. For another example, an array of 128 elements may be used for bi-static radar.

### Connectorless Phased Array Antennas

Signal ears of the phased array antenna (e.g., signals ears 216 of phased array antenna 200) are connected to a feed network that feeds signals to the signal ears. The feed network connects the phased array antenna to a signal generator that controls the feed current transmitted to each of the signal ears. The feed network can also be connected to a receiver that receives signals transmitted to the phased array antenna. According to various embodiments, the feed network for a phased array antenna includes a PCB that is directly connected to the signal ears of the phased array antenna. As described further below, the posts of the signal ears extend through the base plate and are directly soldered to pads of the PCB, which eliminates the need to attach connectors to the posts of the signal ears. This connectorless arrangement between the signals ears and the feed network provides faster assembly and more compact design of the phased array antenna.

In some embodiments, a post of a signal ear of a radiating element extends through the base plate of the phased array antenna and through a through-hole of a PCB mounted to the back side of the based plate. The post is soldered to a pad of the PCB that is connected to a feed line of the PCB.

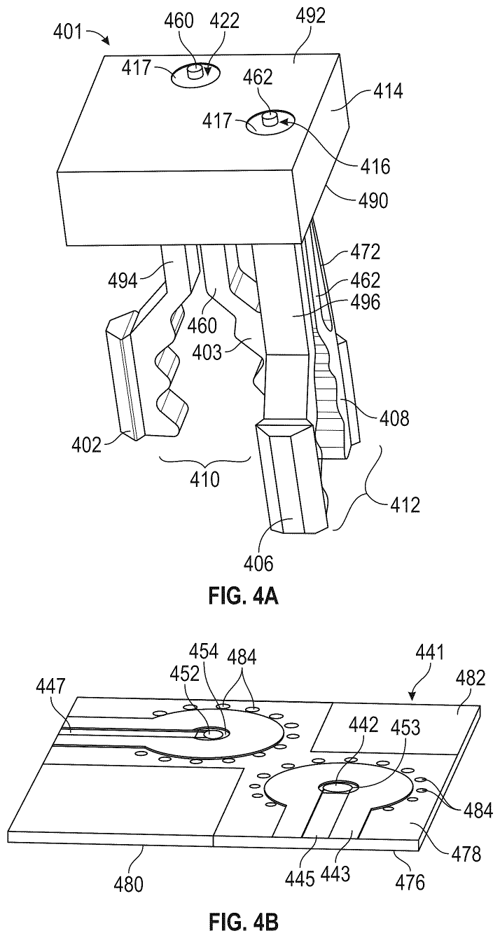

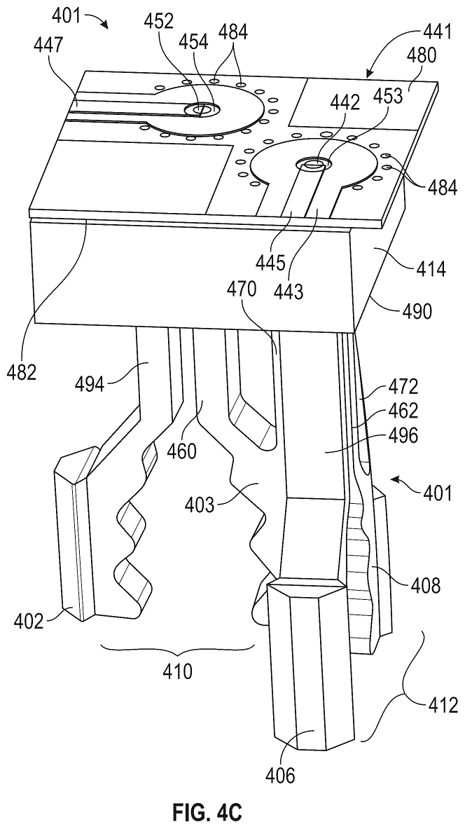

FIG. 4A illustrates an example of a unit cell 401 of a phased array antenna (one unit cell is shown for simplicity) that includes signal ears 403, 408 configured for connectorless mounting to the back side of a PCB, and FIG. 4B illustrates an example of a PCB 441 to which the signal ears 403, 408 can be connected. The unit cell 401 depicted in FIG. 4A includes a base plate 414 and two radiating elements 410 and 412. Base plate 414 and radiating elements 410 and 412 may include any of the characteristics described above with reference to base plate 214 and radiating elements 208 and 210. Radiating element 410 includes a signal ear 403 and ground ear 402, and both the signal ear 403 and ground ear 402 extend outwardly from a first side of the base plate 414. Likewise, radiating element 412 includes a signal ear 408 and ground ear 406, and both the signal ear 408 and ground ear 406 extend outwardly from a first side (radiating side) 490 of the base plate 414.

According to certain embodiments, signal ears 403 includes post 460 and signal ear 408 includes post 462 that extend into respective through-holes 422 or 416 of base plate 414. In some embodiments, a post 460 of the first signal ear 403 and post 462 of signal ear 408 can be electrically isolated from the base plate 414 such that the respective signal ears are not shorted to ground. In some embodiments, post 460 of the first signal ear 403 extends into a through-hole 422 disposed in base plate from the first side 490 of base plate 414 beyond a second side 492 of base plate 414. In some embodiments, the post 462 of signal ear 408 similarly extends into a through-hole 416 disposed in base plate from the first side 490 of base plate 414 beyond a second side 492. In some embodiments, the signal ear posts 460 and 462 are respectively connected to feed lines provided on a PCB mounted to the second side 492 of base plate 414, such as the PCB 441 shown in FIG. 4B, as described further below.

According to certain embodiments, base plate 414 is a solid block of material with through-holes to accommodate post 460 of signal ear 403 and post 462 of signal ear 408 extending from the first (radiating) side 490 through the second (non-radiating) side 492. In some embodiments, the through-holes 416 and 422 may be filled with a dielectric material 417, such as Teflon™, and the signal ear posts (e.g., posts 418 or 420) extend through the dielectric material 417 from a first side 490 of the base plate 414 beyond a second side 492 of the base plate 414.

In some embodiments, a PCB can be mounted to the base plate 414. FIG. 4B depicts a portion of a PCB 441 forming part of a feed network (a portion is shown for simplicity, but it should be understood that the PCB can extend for multiple unit cells, including all unit cells or a section of unit cells, in which case there may be multiple PCBs) configured to electrically connect to the signal ears 403 and 408 of unit cell 401. In some embodiments, PCB 441 includes a first conductive layer 476 disposed on a first side 480 of a dielectric layer 443 of PCB 441 and second conductive layer 478 disposed on the second side 482 of the dielectric layer of PCB 441. In some embodiments, PCB 441 is mounted on the second, non-radiating side 492 of base plate 414 such that the first conductive layer 476 on the first side 480 of the PCB 941 contacts the second non-radiating side 492 of base plate 914.

PCB 401 can include a plurality of feed lines, such as feed lines 445 and 447. Feed lines 445 and 447 are disposed on the second side 482 of the PCB that is not in contact with the second side 492 of base plate 414 when the PCB 441 is connected to the base plate 414. In some embodiments, each of the feed lines enable transmission of a signal to a signal ear connected to the respective feed line. The feed lines 445 and 447 can be electrically isolated from the second conductive layer 478 on the second side 482 of PCB 441 by removing a portion of the conductive layer 478 to expose dielectric material 443 of PCB 441 between each respective feed line (e.g., feed lined 445 and 447). In the illustrated example, a “horseshoe” pattern of dielectric material 443 is exposed surrounding feed lines 445 and 447 in FIG. 4B. As such, the feed lines are insulated from the conductive layer on the second side 482 of PCB 441. According to certain embodiments, the feed lines 445 and 447 extend to catch pads 453 and 454, respectively, on PCB 441 to which other components can be connected to connect the feed lines to other portions of the feed network. For instance, one or more connectors, resistors, capacitors, integrated circuits, and so on may be connected to the feed lines 445 and 447 using through the pads.

As described above, in some embodiments, a plurality of through-holes, such as through-holes 442 and 452 are disposed within the PCB 441, extending from a first side of the PCB 441 through a second side of the PCB 441. In some embodiments, a respective catch pad 453 or 454 is provided at an outer edge of each of the through-holes 442 and 452. The catch pads can be electrically coupled to a respective feed line 445 or 447. As shown in FIG. 4B, catch pad 453 is electrically connected to feed line 445, and catch pad 454 is electrically connected to feed line 447. As described below with reference to FIG. 4C, the signal ears of unit cell 401 can each be electrically connected to a respective feed line of PCB 441 by extending a post (e.g., post 418 or 420) of each signal ear through a respective through-hole soldering an end of the post to via respective catch pad. In some embodiments, the signal ear post may instead be directly soldered to the feed line. In some embodiments, the through-hole is a non-plated through-hole. In some embodiments, the through-hole (e.g., 442, 452) may be a plated through-hole which is electrically coupled to a feed line (e.g., 445, 447), and the signal ear post (e.g., 460, 462) may be soldered to either or both of the feed line or the plated through-hole.

FIG. 4C illustrates an exemplary mounting of the unit cell 401 and the PCB 441. As shown, a conductive surface 482 of the PCB 441 is contacts the second (non-radiating) side 492 of the base plate 414. In the exemplary configuration of FIG. 4C, signal ear post 462 is inserted into through-hole 442 of the PCB. Signal ear post 462 is electrically coupled to feed line 445 by soldering post 462 to catch pad 453. Similarly, signal ear post 460 is inserted into through-hole 452. Signal ear post 460 is electrically coupled to feed line 447 by soldering post 460 to catch pad 454. As described above, in some embodiments, the through-hole is a non-plated through-hole. In other embodiments, the through-hole (e.g., 442, 452) may be a plated through-hole which is electrically coupled to a feed line (e.g., 445, 447), and the signal ear post (e.g., 460, 462) may be soldered to either or both of the feed line or the plated through-hole.

In some embodiments, PCB 441 includes grounding vias 484, which are electrically connected to base plate 414 to provide a path to ground between PCB 441 and base plate 414 when PCB 441 and base plate 414 are connected. In some embodiments, the plurality of grounding vias 484 are disposed within the PCB 441, extending from the first conductive surface on the first side 480 of the PCB 441, which contacts base plate 414, through to the second conductive layer 478 on the second side 482 of the PCB 441. The grounding vias 484 are electrically isolated from the through which the signal ear posts extend (e.g., through-holes 442 and 452) and form an electromagnetic shield around the signal ear posts (e.g., post 460 or 462) mitigating interference with signal transmission and/or reception by the signal ears. In some embodiments, the grounding vias 484 surround the exposed dielectric material that insulates the feed lines from the conductive surface on the first side 480 of PCB 441.

In some embodiments, signal ear 403 includes first post 460 and a second post 470. In some embodiments, signal ear 408 similarly includes first post 462 and second post 472. According to certain embodiments, second posts 470 and 472 are connected to the base plate 414. In some embodiments, posts 470 and 472 are directly integrated into base plate 414. In other embodiments, posts 470 and 472 can be removably attached to base plate 414. In some embodiments, the second post 470 and 472 of each signal ear serves as a support member for each of the respective signal ears 403 and 408. In some embodiments, second posts 470 and 472 are electrically isolated from the base plate. In some embodiments, second posts 470 and 472 are electrically connected to base plate 414 and provide a path to ground for each respective signal ear 403 and 408. It should be understood that the second posts 470 and 472 of the respective signal ears are optional, and the signal ears may be electrically isolated from the base plate.

In some embodiments, radiating element 410 includes a ground ear 402 and radiating element 412 includes a ground ear 406. Ground ear 402 and ground ear 406 include posts 494 and 496, respectively, which are connected to base plate 414. Ground ears 402 and 406 are depicted in FIG. 4 as directly integrated into base plate 414. However, it should be understood that the phased array antenna may be formed by modular components and the ground ears may be removably attached to the baseplate 414 rather than directly integrated into the baseplate 414.

In some embodiments, the signal ear, ground ear, and base plate of each unit cell can be formed from a single piece of conductive material, such that the unit cell 401 can be constructed using an additive manufacturing process. Additive manufacturing can refer to processes in which a common material is joined or solidified under computer control to create an object, with material being added together is a specific way to create the object. By configuring the base plate, signal ear, and ground ear to be manufactured in one piece using a common material, the entire unit cell of a phased array can be manufactured in a single process rather than having to be manufactured as separate components. Such a process can reduce the time and complexity required to manufacture a phased array which can include hundreds or thousands of unit cells. In other embodiments, the unit cell 401 could instead be formed of modular components (e.g., signal ears, ground ears, and a base plate) manufactured separately from one another and assembled to form the unit cell 401.

In some embodiments, the phased array antenna may be connected to a PCB using a BGA. The BGA can be disposed on the second side (non-radiating side) of the base plate between the base plate and a PCB. In some embodiments, the BGA may be disposed between two PCBs connected to the base plate. In such embodiments, one of the two PCBs includes one or more feed lines, and the other acts as a stabilizer. In some embodiments, the PCB acting as a stabilizer is mounted on a first side directly to the base plate, and the PCB that includes the one or more feed lines is provided on a second side of the stabilizing PCB using the BGA provided between the two PCBs. As described above, using the BGA the signal ears of the phased array antenna can be directly connected to transmission feed lines provided on PCBs without any need for additional connectors.

The BGA can thus allow for more efficient connection of the signal ears to a feed network. For instance, the BGA can be arranged on the non-radiating side of the base plate such that the phased array antenna, or subset of unit cells of the phased array antenna, can be connected to a PCB using pick-and place assembly. In pick-and-place assembly, once the BGA is secured to the base plate, the phased array antenna can be oriented and set in place on a PCB such that the signal ears of the antenna contact their respective feed lines on the PCB without need for manually assembling individual connectors between the signal ears and feed lines.

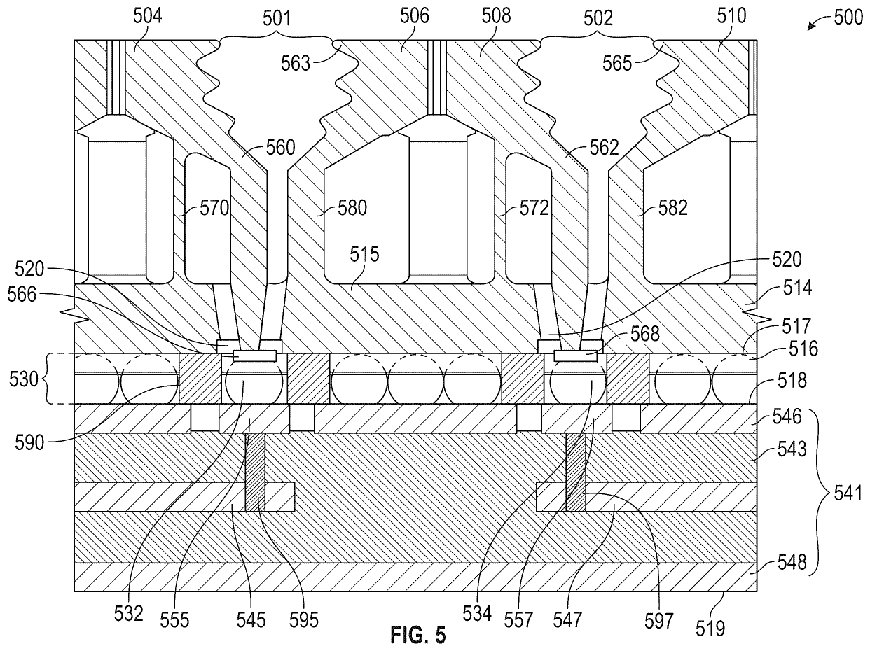

FIG. 5 illustrates a front-section view of a phased array antenna 500 in which a PCB is connected to the base plate 514 of the phased array antenna using a BGA 530. The BGA 530 can be disposed between the non-radiating side of the base plate 514 and a PCB 541.

The front-section view of the phased array antenna shown in FIG. 5 depicts a first radiating element 501 and a second radiating element 502 (two radiating elements are shown for simplicity, but it should be understood that the phased array antenna may include any number of radiating elements). The first radiating element 501 includes signal ear 504 and ground ear 506. The second radiating element 502 includes signal ear 508 and ground ear 510. Each radiating element 501 and 502 is connected to a common base plate 514. In some embodiments, the signal ears 504 and 508 and ground ears 506 and 510 radiate outwardly from a first (radiating) side 515 of the base plate 514. Ground ears 506 and 510 are depicted in FIG. 5 as directly integrated into base plate 514. However, it should be understood that the phased array antenna may be formed by modular components and the ground ears may be removably attached to the baseplate 514 rather than directly integrated into the baseplate 514.

Signal ears 504 and 508 of the phased array antenna are connected to a PCB 541 through contact with a respective ball of the BGA 530 disposed between the base plate 514 and the PCB 541, as described further below. In some embodiments, each of the signal ears 504 and 508 include a first post 560 and 562, respectively, that connects to a feed line provided on a PCB 541 through contact with a ball of the BGA 530. In some embodiments, PCB 541 is mounted to the second (non-radiating) side 517 of base plate 514 using the BGA 530 and includes a first conductive layer 546 disposed on a first side of a dielectric layer 543 and second conductive layer 548 disposed on the second side of the dielectric layer. PCB 541 can be disposed on the second, non-radiating, side 517 of base plate 514 such that the first conductive layer 546 of the PCB 541 contacts a portion of the BGA 530. In some embodiments, the BGA is attached to the second non-radiating side 517 of base plate 514 using a dielectric adhesive 516, such as a solder mask, a dielectric paste, or dielectric tape, such as Kapton® tape.

In some embodiments, first post 560 of the first signal ear 504 extends into a through-hole 520 disposed in base plate 514 from the first side 515 of base plate 514. In some embodiments, the first post 562 of signal ear 508 similarly extends into a through-hole 520 disposed in base plate 514 from the first side 515 of base plate 514. Each of the through-holes 520 is of sufficient diameter to ensure that the first post 560 of signal ear 504 and first post 562 of signal ear 508 does not contact the base plate 514 during operation of the phased array antenna, ensuring that the posts 560 and 562 of signal ears 504 and 508, respectively, remain electrically isolated from the base plate. The respective through-holes 520 can be air-gaps disposed in the base plate 514, or can be filled with a dielectric material.

Post 560 extends through base plate 514 and contacts a first ball 532 of the BGA 530 disposed between the base plate 514 and PCB 541. In some embodiments, a solder mask cap 566 is provided on post 560 to stabilize contact between the first post 560 and the first ball 532. In some embodiments, the first ball 532 contacts a catch pad 555 electrically connected to feed line 545 by via 595. Similarly, post 562 extends through base plate 514 and contacts a second ball 534 of the BGA 530 disposed between the base plate 514 and PCB 541. In some embodiments, a solder mask cap 568 is provided on a first end of post 562 to stabilize contact between the first post 562 of signal ear 508 and the second ball 534, and the second ball 534 contacts a catch pad 557 electrically connected to feed line 547 provided by via 597. In some embodiments, catch pads 555 and 557 are exposed on a first outer surface 518 of PCB 541. In some embodiments, each respective catch pad 555 and 557 exposed outer surface 518 of PCB 541 is connected to a respective feed line 545 and 547 disposed within the dielectric layer 543 between conductive layers 546 and 548 of PCB 541 by a respective via 595 or 597.

In some embodiments, a dielectric material 590 is disposed between the balls of the BGA that are electrically connected to the base plate 514 and each ball of the BGA that is in contact with one of the signal ears of the phased array antenna. As such, each ball of the BGA that is in contact with one of the signal ears of the phased array antenna, for instance ball 532 and 534, are electrically insulated from the remaining balls in the BGA.

According to certain embodiments, the first signal ear 504 and second signal ear 508 of phased array antenna 500 respectively include second posts 570 and 572, which are connected to the base plate 514. The second posts 570 and 572 serve as support members for the first signal ear 504 and second signal ear 508, respectively. In some embodiments, second posts 570 and 572 are electrically isolated form base plate 514. In some embodiments, second posts 570 and 572 are electrically connected to base plate 514 and provide a path to ground for each respective signal ear 504 and 508. It should be understood that the second posts 570 and 572 of the respective signal ears are optional, and the signal ears may be electrically isolated from the base plate.

In some embodiments each of the ground ears, such as ground ears 506 and 510, include a post 580 and 582, respectively, that is directly integrated into the base plate 514. In other words, the base plate 514 and the ground ears 506 and 510 can be fabricated from a common metal piece and are connected to one another by virtue of the direct integration of posts 580 and 582 of the respective ground ears 506 and 510 into the base plate 514. As described above, the base plate 514 can be electrically grounded, and as posts 580 and 582 of the ground ears 506 and 510 are integrated directly into the base plate, they too are provided with a path to ground.

In some embodiments, a plurality of the BGA balls not in contact with one of the signal ears of the phased array antenna provide an electromagnetic shield surrounding each of the respective signal ears. For instance, the balls immediately adjacent to ball 532 on either side of ball 532 form part of an electromagnetic shield surrounding the connection between ball 532 and signal ear 504, thus mitigating risk of interference with the transmission/reception of signals by signal ear 504. While FIG. 5 depicts a cross section of the phased array antenna 500, it should be understood that the shield would be provided by BGA balls on each side of ball 532 (i.e., into and out of the page with respect to the orientation shown in FIG. 5).

### Differential Phased Array Antenna

Described below are various embodiments for a differential phased array antenna. Differential antennas transmit information signals using two complementary signals. As such, in the differential phased array antenna embodiments described herein, each unit cell includes two signal ears. Each of the signa ears receives a respective signal from the feed network connected to the phased array antenna. The respective signals received by each of the signal ears of the unit cell form a differential pair, and the two signal ears generate a single signal for transmission based on the differential pair, as described further below.

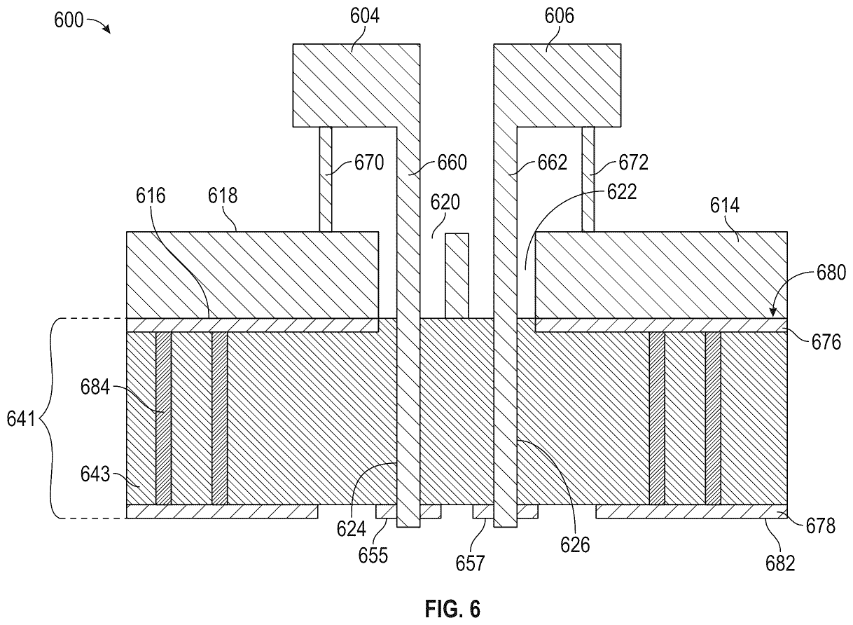

FIG. 6 illustrates a front-section view of a phased array antenna including unit cell 602. Unit cell 602 includes a differential pair of signal ears including signal ear 604 and signal ear 606, wherein signal ear 604 and signal ear 606 are connected to a PCB 941. In some embodiments, signal ear 604 and signal ear 606 generate a signal based on a differential signal pair transmitted to the first signal ear 604 by a first feed line connected to catch pad 655 and a second signal transmitted to the second signal ear 606 by a second feed line connected to catch pad 657. In some embodiments, the first signal ear 604 includes a first post 660 electrically isolated form the base plate 614 and the second signal ear 606 includes a first post 662 also electrically isolated from the base plate 914.

In some embodiments, first signal ear 604 and second signal ear 606 of phased array antenna 600 respectively include second posts 670 and 672, which are connected to the base plate 614. In some embodiments, posts 670 and 672 are directly integrated into base plate 614. In other embodiments, posts 670 and 672 can be removably attached to base plate 614. The second posts 670 and 672 serve as support members for the first signal ear 604 and second signal ear 606, respectively. In some embodiments, second posts 670 and 672 are electrically isolated from the base plate. In some embodiments, second posts 670 and 672 are electrically connected to base plate 614 and provide a path to ground for each respective signal ear 604 and 606. It should be understood that the second posts 670 and 672 of the respective signal ears are optional, and the signal ears may be electrically isolated from the base plate.

In some embodiments, first post 660 of signal ear 604 extends into a through-hole 620 disposed in base plate from the first side 618 of base plate 614 beyond a second side 616 of base plate 614. In some embodiments, post 662 of signal ear 606 similarly extends into a through-hole 622 disposed in the base plate 614 from the first side 618 of base plate 614 beyond a second side 616. In some embodiments, the through-hole is a non-plated through-hole. In some embodiments, the through-hole (e.g., 624, 626) may be a plated through-hole which is electrically coupled to a feed line provided on a PCB 641 mounted to base plate 614, for instance, by contact with a respective catch pad 655 or 657.

A feed network including a PCB can be mounted to the base plate 614 of phased array antenna 600. FIG. 6 depicts a portion of a PCB 641 forming part of a feed network (a portion is shown for simplicity, but it should be understood that the PCB can extend for multiple unit cells, including all unit cells or a section of unit cells, in which case there may be multiple PCBs) configured to electrically connect to the signal ears of phased array antenna 600. In some embodiments, PCB 641 includes a first conductive layer 676 disposed on a first side 680 of a dielectric layer 643 of PCB 641 and second conductive layer 678 disposed on the second side 682 of the dielectric layer. In some embodiments, PCB 641 is mounted on the second, non-radiating side 616 of base plate 614 such that the conductive layer 676 on the first side 680 of the dielectric layer 643 of the PCB 941 contacts the non-radiating side 616 of base plate 614.

In some embodiments, the signal ear posts 660 and 662 are respectively connected to the feed lines provided on PCB 614. As described above, PCB 641 can include a plurality of feed lines, such as feed lines 645 and 647 (not shown), each electrically connected to a respective catch pad such as catch pad 655 or 657. Feed lines 645 and 647 are disposed on a side of the PCB that is not in contact with the second side 616 of base plate 614 when the PCB 641 is connected to the base plate 614. In some embodiments, each of the feed lines 645 and 647 enable transmission of a signal to a signal ear connected to the respective feed line. The feed lines 645 and 647 can be electrically isolated from a conductive layer 682 of PCB 641 by removing a portion of the conductive layer on the first side 680 to of the dielectric layer expose dielectric material of dielectric layer 643 of PCB 641 between each respective feed line (e.g., feed lined 645 and 647).

The signal ears 604 and 606 can be electrically connected to the PCB 641 by a direct connection to a respective feed line of the PCB 641. In some embodiments, the first post 660 of signal ear 604 extends through through-hole 624 of PCB 641 to connect to feed line 645 by contact with catch pad 655 and post 662 of signal ear 606 extends through through-hole 626 of PCB 641 to connect to feed line 647 by contact with catch pad 657. As shown post 660 and post 662 of signal ears 604 and 606, respectively, extend through base plate 614 beyond the non-radiating side 616 of base plate 614. Posts 660 and 662 extend from a first side of PCB 641 through through-holes 624 and 626, respectively, beyond a second side of PCB 641. On the second side of PCB 641, feed lines 645 and 647 are electrically coupled to the posts 660 and 662, respectively, catch pad 655 or 657.

In some embodiments, catch pads 655 and 657 are provided at an outer edge of each of the through-holes 624 and 626, respectively. The catch pads 655 and 657 can be electrically coupled to a respective feed line 645 or 647 similarly to the configuration shown in FIG. 4B. As shown in FIG. 4B, catch pad 453 is electrically connected to feed line 445, and catch pad 454 is electrically connected to feed line 447. The signal ears 604 and 606 can each be electrically connected to a respective feed line of PCB 641 by extending a post 660 or 662, respectively, of each signal ear through a respective through-hole and soldering an end of the post to via respective catch pad, which is electrically connected to the feed line. In some embodiments, the signal ear post may instead be directly soldered to the feed line. In some embodiments, the through-holes 624 and 626 are non-plated through-holes. In some embodiments, the through-holes 624 and 626 may be plated through-holes that are electrically coupled to a feed line and the respective signal ear post may be soldered to either or both of the feed line or the plated through-hole.

In some embodiments, a plurality of grounding vias 684 are disposed within the PCB 641, extending from the first conductive layer 676 on the first side 680 of the dielectric layer 643 of the PCB 441 through to the second conductive layer on the second side 682 of the dielectric layer 643 of the PCB 641. The grounding vias 684 provide a path to ground between base plate 614 and PCB 641. In some embodiments, the one or more grounding vias 684 are electrically isolated from the PCB through-holes through which the signal ear posts extend (through-holes 624 and 626) and form an electromagnetic shield around the signal ear posts (e.g., post 660 and 662). In a differential antenna configuration, a plurality of grounding vias may surround a differential pair of signal ears. In a single ended antenna configuration, the plurality of grounding vias may surround each individual signal ear of the phased array antenna.

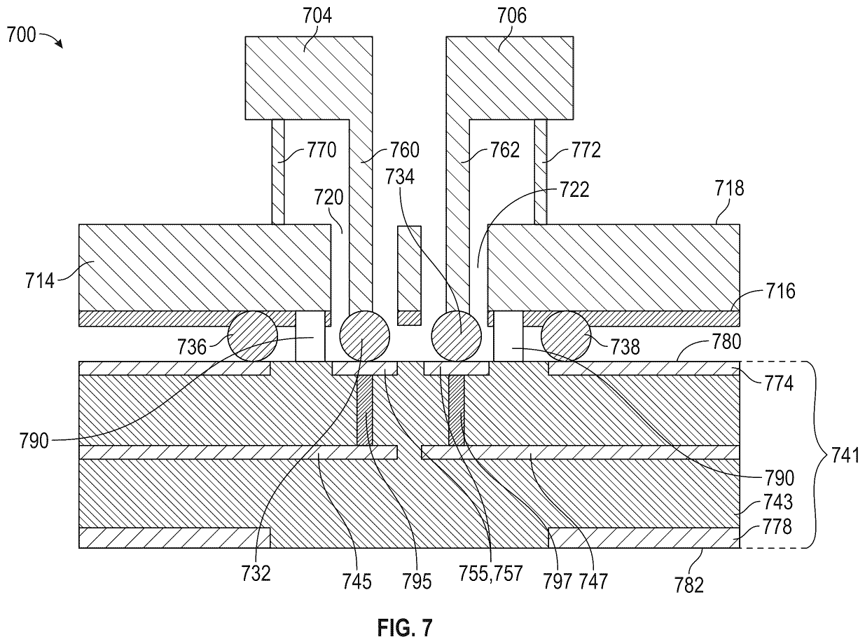

FIG. 7 illustrates a front-section view of a phased array antenna 700 in which a unit cell 702 includes a differential pair of signal ears including signal ear 704 and signal ear 706, similar to FIG. 6 above, however signal ear 704 and signal ear 706 are connected to a PCB 741 using a BGA 730. In some embodiments, the phased array antenna 700 includes a base plate 714 and a plurality of unit cells, including a first unit cell 702 that includes a first signal ear 704 and a second signal ear 706 for generating a signal based on a differential signal pair transmitted to the first signal ear 704 by a first feed line 745 and a second signal transmitted to the second signal ear 706 by a second feed line 747.

In some embodiments, signal ear 704 and signal ear 706 respectively include posts 760 and 762. Posts 760 and 762 are electrically isolated from the base plate 714.

According to certain embodiments, base plate 714 is a solid block of material with through-holes 720 and 722 to accommodate the signal ears (e.g., signal ears 704 and 706) of each respective unit cell of the phased array antenna 700. In some embodiments, first post 760 of signal ear 704 extends into a through-hole 720 disposed in base plate 714 from the first (radiating) side 718 of base plate 714. In some embodiments, post 762 of signal ear 706 similarly extends into a through-hole 722 disposed in the base plate 714 from the first side 718 of base plate 714.

Each of the through-holes 720 and 722 is of sufficient diameter to ensure that the post 760 of signal ear 704 and post 762 of signal ear 706 does not contact the base plate 714 during operation of the phased array antenna, ensuring that the posts 760 and 762 of signal ears 704 and 706, respectively, remain electrically isolated from the base plate. The respective through-holes 720 and 722 can be air-gaps disposed in the base plate 714, or can be filled with a dielectric material (e.g., Teflon™) that insulates the signal ear posts (e.g., 760 and 762) from the base plate 714.

A feed network including a PCB can be mounted to the base plate 714 of phased array antenna 700. FIG. 7 depicts a portion of a PCB 741 forming part of a feed network (a portion is shown for simplicity, but it should be understood that the PCB can extend for multiple unit cells, including all unit cells or a section of unit cells, in which case there may be multiple PCBs) configured to electrically connect to the signal ears of phased array antenna 700. In some embodiments, PCB 741 includes a first conductive layer 776 disposed on a first side 780 of a dielectric layer 743 and second conductive layer 778 disposed on the second side 782 of the dielectric layer. In some embodiments, PCB 741 is mounted on the second, non-radiating side 716 of base plate 714 such that the conductive layer 776 of the PCB 741 contacts the non-radiating side 716 of base plate 714.

In some embodiments, post 760 of signal ear 704 extends into a first through-hole 720 of base plate 714 to electrically connect to a first feed line 745, which provides a first signal to signal ear 704, and post 762 of signal ear 706 extends into a second through-hole 722 of base plate 714 to electrically connect to a second feed line 747, which provides a second signal to signal ear 706.

In some embodiments, base plate 714 of the phased array antenna is connected to PCB 741 using a BGA 730 disposed between the base plate 714 and the PCB 741. In some embodiments, the BGA is attached to the base plate 714 using a dielectric adhesive 716. In some embodiments, the dielectric adhesive 716 is any one of a solder mask, dielectric paste, or dielectric tape, such as Kapton® tape.

In some embodiments, post 760 of signal ear 704 contacts a first ball 732 of the BGA and post 762 of signal ear 706 contacts a second ball 734 of the BGA. In some embodiments, a solder mask cap (not shown) may be provided on a first end of the first post 760 and second post 762 to stabilize contact between the first post 760 and the first ball 732, and between the second post 762 and second ball 734. In some embodiments, the first ball 732 of the BGA 730 contacts a catch pad 755 electrically connected to a first feed line 745 by via 795. Similarly, second ball 734 may contact a catch pad 757 electrically connected to a second feed line 747 by via 797. As such, ball 732 and 734 respectively connect two feed lines 745 and 747 provided on PCB 741 to signal ears 704 and 706. In some embodiments, catch pads 755 and 757 are exposed on a first outer surface 780 of PCB 741. In some embodiments, each respective catch pad 755 and 757 exposed outer surface 780 of PCB 741 is connected to a respective feed line 745 and 747 disposed within the dielectric layer 743 between conductive layers 776 and 778 of PCB 741 by a respective via 795 or 797.

In some embodiments, a plurality of the balls of the BGA not in contact with one of the plurality of signal ears are in contact with both the base plate 714 and the PCB 741. For instance, ball 736 and ball 738 are in contact with both the base plate 714 and a conductive surface of the PCB 741, thus providing a path to ground between the base plate 714 and PCB 741. In some embodiments, a dielectric material 790 is disposed between a plurality of balls of the BGA that are electrically connected to the base plate 714 and each ball of the BGA that is in contact with one of the signal ears (e.g., ball 732 connected to signal ear 704 and ball 734 connected to signal ear 706). For instance, dielectric material 790 is disposed between ball 736 and ball 732, as well as between ball 738 and ball 734. As such, each ball of the BGA that is in contact with one of the signal ears of the phased array antenna is electrically insulated from the remaining balls in the BGA to ensure that the signal ear is not shorted to ground.

In some embodiments, a plurality of the BGA balls not in contact with one of the signal ears of the phased array antenna provide an electromagnetic shield surrounding each of the respective signal ears. For instance, ball 736 forms part of an electromagnetic shield surrounding the connection between ball 732 and signal ear 704, thus mitigating risk of interference with the transmission/reception of signals by signal ear 704. While FIG. 7 depicts a cross section of the phased array antenna 700, it should be understood that the shield would be provided by BGA balls on the front and rear side of ball 732 as well (i.e., into and out of the page with respect to the orientation shown in FIG. 7). In a single ended antenna configuration, the plurality of the balls of the BGA not in contact with one of the plurality of signal ears may surround each individual signal ear of the phased array antenna to provide an electromagnetic shield around each signal ear. In a differential antenna configuration, the plurality of the balls of the BGA not in contact with one of the plurality of signal ears surround a differential pair of signal ears to provide an electromagnetic shield around the differential pair, as shown in FIG. 7.

According to certain embodiments, the first signal ear 704 and second signal ear 706 of phased array antenna 700 respectively include second posts 770 and 772, which are connected to the base plate 714. The second posts 770 and 772 serve as support members for the first signal ear 704 and second signal ear 706, respectively. In some embodiments, second posts 770 and 772 are electrically isolated from base plate 714. In some embodiments, second posts 770 and 772 are electrically connected to base plate 714 and provide a path to ground for each respective signal ear 704 and 706. It should be understood that the second posts 770 and 772 of the respective signal ears are optional, and the signal ears may be electrically isolated from the base plate.

In some embodiments, in place of the BGA balls, an elastomeric connector (not shown) can be disposed between each of the first posts 760 and 762 of signal ears 704 and 706, respectively, and PCB 741 to provide an electrical connection between each of the respective signal ears (e.g., 704 and 706) and their respective transmission feed lines (e.g., 745 and 747) of the PCB 641. In some embodiments, the first post 760 of the first signal ear 704 is connected to a first elastomeric connector on a first side of the elastomeric connector. In some embodiments, a second side of the first elastomeric connector contacts a first catch pad 755 on PCB 741, thus electrically connecting the first post 760 of signal ear 704 to the feed line 745 through via 795. Similarly, in some embodiments, post 762 of the second signal ear 706 is connected to a second elastomeric connector on a first side of the elastomeric connector, and a second side of the second elastomeric connector contacts a second catch pad 757, thus electrically connecting the first post 762 of signal ear 706 to the feed line 747 through via 797. In some embodiments, the elastomeric connectors each comprise a solderable metal flange and a conductive elastomer. In some embodiments, the elastomeric connectors are Invisipin® Solderable conductive elastomer pins.

### Stabilizing PCB for BGA Connection

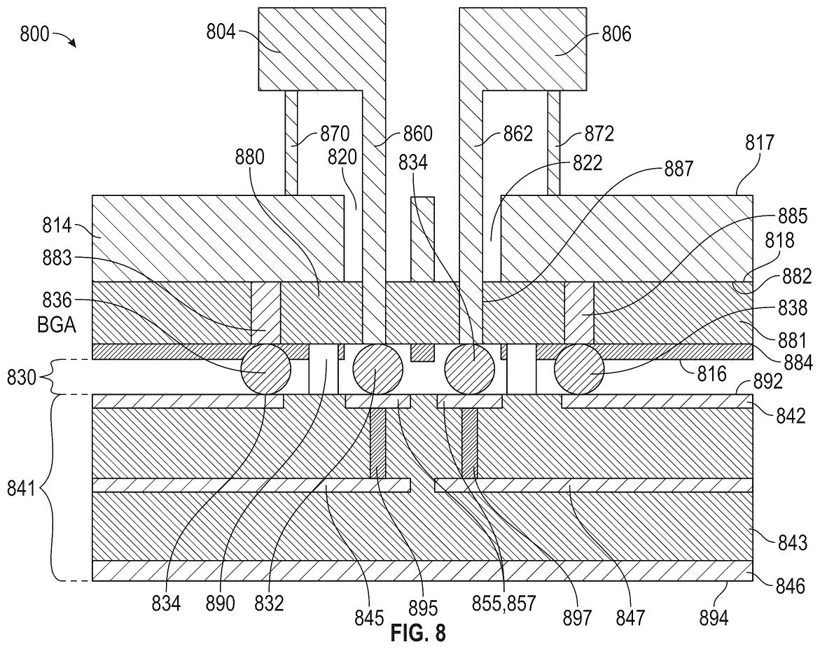

The exemplary phased array antennas depicted in FIGS. 5 and 8 illustrate how a feed network including a PCB can be mounted to the phased array antenna using a BGA. Below, FIG. 8 illustrates how a second PCB (the “stabilizing PCB”) can be included between the PCB that provides transmission feed signals (the “active PCB”) to the signal ears of the antenna and the base plate of the antenna. The stabilizing PCB may not include any active transmission lines, but instead can acts as a stabilizer for the connection between the signal ears and the BGA. As described in detail below, the signal ear posts that contact the BGA are inserted into the stabilizing PCB. The stabilizing PCB thus surrounds a portion of the signal ear posts, mitigating the potential for disconnect between the signal ear posts and BGA, for instance, due to vibration or other movement during operation of the phased array antenna.

FIG. 8 illustrates a front-section view of a phased array antenna 800 including unit cell 802. Unit cell 802 includes a differential pair of signal ears including signal ear 804 and signal ear 806, wherein signal ear 804 and signal ear 806 are connected to a PCB 841 (the active PCB) using a BGA 830 disposed between PCB 841 and PCB 881 (the stabilizing PCB). While FIG. 8 depicts a unit cell including a differential a differential pair of signal ears, it should be understood that the unit cell could instead implement a single ended configuration, in which the unit cell 802 includes a signal ear (e.g., signal ear 804) and a ground ear, such as ground ear 510, described above with reference to FIG. 5.

In some embodiments, similar to phased array antenna 700 of FIG. 7, the phased array antenna 800 includes a base plate 814 and a plurality of unit cells, including unit cell 802 that includes a first signal ear 804 and a second signal ear 806 for generating a signal based on a differential signal pair transmitted to the first signal ear 804 by a first feed line 845 and a second signal transmitted to the second signal ear 806 by a second feed line 847. In some embodiments, the first signal ear 804 includes a post 860 electrically isolated from the base plate 814 and the second signal ear 806 includes a post 862 electrically isolated from the base plate 814.

According to certain embodiments, base plate 814 is a solid block of material with through-holes 820 and 822 to accommodate posts 860 and 862 of the signal ears 804 and 806, respectively, of the phased array antenna 800. Posts 860 and 862 respectively extend through the through-holes 820 and 822 of base plate 814 from a first (radiating) side 817 of base plate 814 beyond a second (non-radiating) side 818 of base plate 814. In some embodiments, the through-holes 820 and 822 are filled with a dielectric material (e.g., Teflon™) that insulates the signal ear posts (e.g., 860 and 862) from the base plate 814.

In some embodiments, stabilizing PCB 881 is mounted to the second (non-radiating) side 818 of base plate 814. Posts 860 and 862 extend through respective through-holes disposed in stabilizing PCB 881 from a first side 882 beyond a second side 884 of PCB 881. In some embodiments, stabilizing PCB 881 does not include any feed lines/active transmission lines. As such, in some embodiments, stabilizing PCB 881 serves as a stabilizer for the connection between the signal ear posts and the feed lines provided on active PCB 841 without contributing to the transmission of or reception of signals by the phased array antenna 800.

A feed network including active PCB 841 can be mounted to stabilizing PCB 881 on the second side 884 of stabilizing PCB 881 using a BGA 830. In some embodiments, the BGA is attached to the second side of PCB 881 using a dielectric adhesive 816, such as a solder mask, a dielectric paste, or dielectric tape, such as Kapton® tape between PCB 881 and a first side 892 of active PCB 841. FIG. 8 depicts a portion of active PCB 841 forming part of the feed network (a portion is shown for simplicity, but it should be understood that the PCB can extend for multiple unit cells, including all unit cells or a section of unit cells, in which case there may be multiple PCBs) configured to electrically connect to the signal ears of phased array antenna 800. In some embodiments, active PCB 841 includes a first conductive layer 842 disposed on first side 892 of a dielectric layer 843 and second conductive layer 846 disposed on the second side 894 of the dielectric layer. Active PCB 841 includes feed lines 845 and 847 which are connected to catch pads 855 and 857 provided on a first side 892 of active PCB 841, which is mounted to stabilizing PCB 881 using BGA 831. Feed lines 845 and 847 are respectively connected to signal ear posts 860 and 862, as described below.

In some embodiments, post 860 of signal ear 804 extends through through-hole 887 disposed in stabilizing PCB 881 from a first side 882 beyond a second side 884 of stabilizing PCB 881 to contact a first ball 832 of the BGA 830. In some embodiments, post 862 of signal ear 806 similarly extends through through-hole 889 of stabilizing PCB 881 to contact a second ball 834 of the BGA 830. The first ball 832 and second ball 834 in turn contact catch pads 855 and 857, respectively, of active PCB 841, which are electrically coupled to feed lines 845 and 847 by vias 895 and 897. In some embodiments, a solder mask may be provided on a first end of the first post 860 and second post 862 to stabilize contact between the first post 860 and the first ball 832, and the second post 862 and second ball 834. In some embodiments, catch pads 855 and 857 are exposed on side 892 of PCB 841. In some embodiments, each respective catch pad 855 and 857 exposed on side 892 of PCB 841 is connected to a respective feed line 845 and 847 disposed within the dielectric layer 843 between conductive layers 842 and 846 of PCB 841 by a respective via 895 or 897.

In some embodiments, a dielectric material 890 is disposed between the balls of the BGA that are electrically connected a conductive surface of stabilizing PCB 881 and each ball of the BGA (e.g., ball 832 and 834) that is in contact with one of the signal ears (e.g., 804 and 806) of the phased array antenna 800. As such, each ball of the BGA that is in contact with one of the signal ears of the phased array antenna are electrically insulated from the remaining balls in the BGA to ensure that the signal ear is not shorted to ground.

In some embodiments, a plurality of the balls of the BGA not in contact with one of the plurality of signal ears (e.g., balls 836 and 838) are electrically coupled to the base plate 814 through contact one a first side of each ball with a plurality of conductive vias 883 extending through stabilizing PCB 881 that are electrically connected to base plate 814. A second side of each of the balls of the BGA not in contact with one of the plurality of signal ears contacts a conductive surface of active PCB 841. As such, the plurality of the balls of the BGA not in contact with one of the plurality of signal ears provide a path to ground between base plate 814, stabilizing PCB 881, and active PCB 841.

In some embodiments, the plurality of the balls of the BGA not in contact with one of the plurality of signal ears (e.g., balls 836 and 838) and the corresponding conductive vias 883 in contact with each of the BGA balls form an electromagnetic shield around the signal ear posts (e.g., posts 860 and 862) of the respective signal ears (e.g., 804 and 806). In a differential antenna configuration, the plurality of the balls of the BGA not in contact with one of the plurality of signal ears surround a differential pair of signal ears to provide an electromagnetic shield around the differential pair. In a single ended antenna configuration, the plurality of the balls of the BGA not in contact with one of the plurality of signal ears may surround each individual signal ear of the phased array antenna to provide an electromagnetic shield around each signal ear.

According to certain embodiments, the first signal ear 804 and second signal ear 806 of phased array antenna 800 respectively include second posts 870 and 872, which are connected to the base plate 814. The second posts 870 and 872 serve as support members for the first signal ear 804 and second signal ear 806, respectively. In some embodiments, second posts 870 and 872 are electrically isolated from base plate 814. In some embodiments, second posts 870 and 872 are electrically connected to base plate 814 and provide a path to ground for each respective signal ear 804 and 706. It should be understood that the second posts 870 and 872 of the respective signal ears are optional, and the signal ears may be electrically isolated from the base plate.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A phased array antenna comprising:
a base plate; and
a plurality of unit cells, wherein each unit cell comprises:
a signal ear that extends outwardly from a first side of the base plate, the signal ear comprising a post that extends through the base plate beyond a second side of the base plate, wherein the post is electrically isolated from the base plate; and
a first printed circuit board (PCB) comprising a feed line directly connected to the post.

2. The phased array antenna of claim 1, wherein the post extends through an airgap or a dielectric material disposed within the base plate.

3. The phased array antenna of claim 1, further comprising a ground ear that extends outwardly from the first side of the base plate, the ground ear comprising a post connected to the base plate.

4. The phased array antenna of claim 1, wherein the post is directly connected to the first PCB by extending the post through a through-hole of the first PCB from a first side of the PCB to a second side of the PCB and soldering the post to a catch pad on the second side of the PCB.

5. The phased array antenna of claim 4, wherein the through-hole is electrically connected to the feed line.

6. The phased array antenna of claim 5, wherein the feed line is electrically isolated from a conductive surface on the second side of the PCB comprising the feed line.

7. The phased array antenna of claim 1, wherein the first PCB comprises a plurality of grounding vias, wherein the plurality of grounding vias are electrically connected to the base plate to provide a path to ground.

8. The phased array antenna of claim 7, wherein the plurality of grounding vias form an electromagnetic shield around the post.

9. The phased array antenna of claim 1, wherein a second PCB is disposed between the base plate and the first PCB, and wherein the post extends through a through-hole of the second PCB, wherein the second PCB does not comprise a feed line, and the post is directly connected to the first PCB.

10. The phased array antenna of claim 9, wherein the post is directly connected to the first PCB by connecting the post to a first ball of a ball grid array (BGA) disposed between the second PCB and the first PCB, wherein the first ball contacts the feed line.

11. The phased array antenna of claim 9, wherein the second PCB comprises a plurality of grounding vias, wherein the plurality of grounding vias are electrically connected to the base plate to provide a path to ground.

12. The phased array antenna of claim 11, wherein the one or more grounding vias are electrically isolated from the through-hole through which the post extends.

13. The phased array antenna of claim 11, wherein a grounding via of the plurality of grounding vias contacts a second ball of the BGA in contact with a conductive surface of the first PCB to provide a path to ground between the base plate, the first PCB, and the second PCB.

14. The phased array antenna of claim 13, wherein the grounding via and the second ball form a part of an electromagnetic shield around the post.

15. A phased array antenna comprising:
a base plate; and
a plurality of unit cells, wherein each unit cell comprises:
a signal ear comprising a post, wherein the post is electrically isolated from the base plate, and wherein the post is connected to a first printed circuit board (PCB) comprising a feed line by a contact with a first ball of a ball grid array (BGA), wherein the first ball is connected to the feed line.

16. The phased array antenna of claim 15, wherein the post extends through an airgap disposed within the base plate.

17. The phased array antenna of claim 15, wherein the post extends through a dielectric material disposed within the base plate.

18. The phased array antenna of claim 15, further comprising a ground ear that extends outwardly from the first side of the base plate, the ground ear comprising a post connected to the base plate.

19. The phased array antenna of claim 15, wherein the BGA is disposed between the base plate and the first PCB comprising the feed line.

20. The phased array antenna of claim 15, wherein a plurality of balls of the BGA other than the first ball form an electromagnetic shield around the first ball and the post.

21. The phased array antenna of claim 15, wherein a second PCB is disposed between the base plate and the first PCB, and wherein the BGA is disposed between the second PCB and the first PCB.

22. The phased array antenna of claim 21, wherein the post extends through a through-hole of the second PCB, wherein the second PCB does not comprise a feed line, and the post is directly connected to the first PCB by contact with the first ball of the BGA disposed between the second PCB and the first PCB.

23. The phased array antenna of claim 21, wherein the second PCB comprises a plurality of grounding vias, wherein the plurality of grounding vias are electrically connected to the base plate and the first PCB to provide a path to ground between the base plate, the first PCB, and the second PCB.

24. The phased array antenna of claim 23, wherein the plurality of grounding vias are electrically isolated from the through-hole through which the post extends.

25. The phased array antenna of claim 23, wherein a grounding via of the plurality of grounding vias contacts a second ball of the BGA, and wherein the second ball contacts a conductive surface of the first PCB to provide a path to ground between the base plate, the first PCB, and the second PCB.

26. The phased array antenna of claim 25, wherein the grounding via and the second ball form a part of an electromagnetic shield around the post.

27. A phased array antenna comprising:
a base plate configured to provide a path to ground; and
a plurality of unit cells, wherein a first unit cell comprises a first signal ear and a second signal ear adjacent to the first signal ear for generating a signal based on a differential signal pair, and
wherein the first signal ear comprises a first post electrically isolated from the base plate and second signal ear comprises a second post electrically isolated from the base plate.

28. The phased array antenna of claim 27, wherein the first signal ear is connected to a first feed line by a contact between the first post and the first feed line, and wherein the second signal ear is connected to a second feed line by a contact between the second post and the second feed line.

29. The phased array antenna of claim 28, wherein the first and second feed line are provided on a first PCB.

30. The phased array antenna of claim 29, wherein the first post is connected to the first feed line by extending the first post through a first through-hole of the first PCB from a first side of the first PCB to a second side of the first PCB and soldering the first post to a first catch pad electrically connected to the first feed line on the second side of the first PCB.

31. The phased array antenna of claim 29, wherein the second post is connected to the second feed line by extending the second post through a second through-hole of the first PCB from a first side of the first PCB to a second side of the first PCB and soldering the second post to the second catch pad electrically connected to the second feed line on the second side of the first PCB.

32. The array antenna of claim 29, wherein a second PCB is disposed between the base plate and the first PCB, and wherein the first and second feed line are provided on the first PCB, and wherein a ball grid array (BGA) is disposed between the first PCB and the second PCB.

33. The phased array antenna of claim 32, wherein the first post extends through a first through-hole of the second PCB and the second post extends through a second through-hole of the second PCB, and wherein the first post directly connects to the first feed line by contacting a first ball of the BGA in contact with the first feed line, and wherein the second post directly connects to the second feed line by contacting a second ball of the BGA in contact with the second feed line.

34. The phased array antenna of claim 32, wherein the first PCB and second PCB respectively comprise one or more grounding vias, wherein the one or more grounding vias are electrically connected to the base plate to provide a path to ground.

35. The phased array antenna of claim 33, wherein the one or more grounding vias are electrically isolated from the first through-hole and the second through-hole.

36. The phased array antenna of claim 33, wherein the one or more grounding vias respectively contact one of more balls of the BGA other than the first ball and the second ball, and wherein the one of more balls of the BGA other than the first ball and the second ball contact a conductive surface of the first PCB and the second PCB to provide a path to ground between the base plate, the first PCB, and the second PCB.

37. The phased array antenna of claim 27, wherein the base plate comprises a plurality of airgaps disposed within the base plate.

38. The phased array antenna of claim 37, wherein the first post is disposed within a first airgap of the plurality of airgaps and the second post is disposed within a second airgap of the plurality of airgaps.

39. The phased array antenna of claim 27, wherein the first signal ear comprises a third post connected to the base plate and the second signal ear comprises a fourth post connected to the base plate.
